(19) United States
(12) Patent Application Publication
(10) Pub. No.: US 2014/0333627 A1
(43) Pub. Date: Nov. 13, 2014

(54) TERMINAL DEVICE AND METHOD FOR GENERATING INTERFACE SHOWING NETWORK INFORMATION

(71) Applicants: Fu Tai Hua Industry (Shenzhen) Co., Ltd., Shenzhen (CN); HON HAI PRECISION INDUSTRY CO., LTD., New Taipei (TW)

(72) Inventors: WEI SONG, Shenzhen (CN); CHIH-SAN CHIANG, New Taipei (TW); HUA-DONG CHENG, Shenzhen (CN); HAI-SEN LIANG, Shenzhen (CN); TE-JIA LIU, Shenzhen (CN); LING-JUAN JIANG, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 14/271,465

(22) Filed: May 7, 2014

(30) Foreign Application Priority Data
May 7, 2013 (CN) 2013101632818

(51) Int. Cl. H04L 12/26

(52) U.S. Cl. CPC H04L 43/045; H04L 43/0876
USPC 345/440

(57) ABSTRACT

Method for generating an interface for displaying network information comprising, obtaining signal strength of a network connecting a terminal device and a server, uploading information and downloading information between the terminal device and the server in real time. A network interface is generated according to the signal strength of network, an upload interface is generated according to the upload information, and a download interface is generated according to the download information. The upload interface, the network interface and the download interface are displayed and update in real time.

### FIELD

The present disclosure relates to a terminal device having an interface showing network information, and a method for generating the interface.

### BACKGROUND

Networks play an important role in our daily life. Network traffic and network speed are key terms for measuring network status. Usually, a user can get information about the network traffic and speed by clicking an icon generated by software.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block view of an embodiment of a terminal device having an interface for displaying network information.

FIG. 2 is a schematic view of an embodiment of an interface in a first state showing network information.

FIG. 3 is a schematic view of an interface in a second state showing network information.

FIG. 4 is a schematic view of an interface in colors showing network information.

FIG. 5 is a flowchart of a method for generating an interface showing network information.

FIG. 6 is a flowchart of a method for interacting with the interface showing network information.

### DETAILED DESCRIPTION

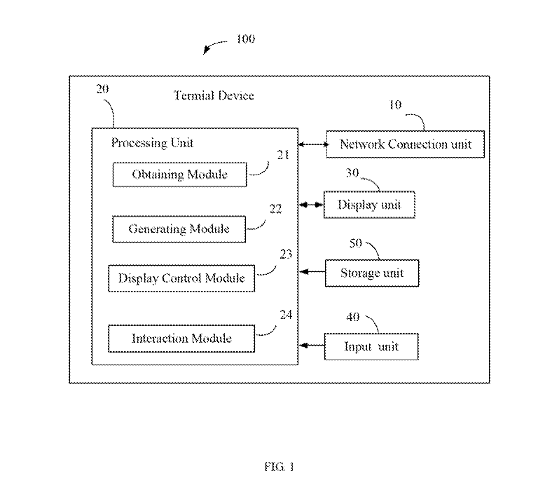

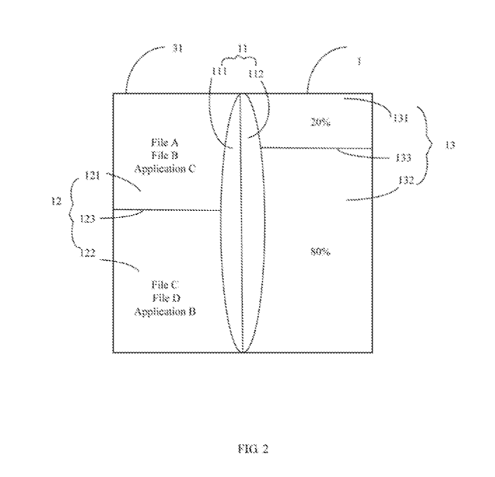

FIG. 1 illustrates a terminal device 100, and FIG. 2 illustrates an interface generated by the terminal device 100 showing network information. The terminal device 100 includes a network connection unit 10 and connects to a server (not shown) via the network connection unit 10 for downloading data from the server or uploading data from the terminal device 100 to the server. The terminal device 100 also includes a processing unit 20 and a display unit 30. The display unit 30 includes a display region 31 (shown in FIG. 2). In at least one embodiment, the display unit 30 is a touch screen.

The processing unit 20 includes an obtaining module 21, a generating module 22 and a display control module 23.

The obtaining module 21 obtains real-time signal strength of the network connecting the terminal device 100 and the server, real-time upload information and real-time download information between the terminal device 100 and the server. In at least one embodiment, the signal strength of the network includes upload speed and download speed. The upload information includes size and detail information of uploaded data, and size and detail information of data to be uploaded. In addition, the download information includes size and detail information of downloaded data, and size and detail information of data to be downloaded.

The generating module 22 generates an interface 1 for showing the network information according to the real-time obtained information obtained by the obtaining module 21. The interface includes a network status display region 11, an upload status display region 12 and a download status display region 13. In the embodiment, the generated interface 1 occupies the whole display region 31 of the display unit 30. The network status display region 11 is for showing the signal strength of the network according to the obtained signal strength of the network. The upload status display region 12 is for showing the upload information according to the obtained upload information. The download status display region 13 is for showing the download information according to the obtained download information.

The network status display region 11 includes a first sub-display region 111 for showing the upload speed of the network and a second sub-display region 112 for showing the download speed of the network. The size of the network status display region 11 is related to the signal strength of the network. For example, when the signal strength of the network is less than 2 megabytes (M), the size of the network status display region 11 occupies 10 percent of the size of the interface 1. When the signal strength of the network is between 2M and 3M, the size of the network status display region 11 occupies 20 percent of the size of the interface 1, when the signal strength of the network is more than 3M, the size of the network status display region 11 occupies 50 percent of the size of the interface 1. The size of the first sub-display region 111 is related to the upload speed of the network, and the size of the second sub-display region 112 is related to the download speed of the network. The ratio of the size of the first sub-display region 111 to the size of the second sub-display region 112 is proportional to the ratio of upload speed to download speed. When the upload speed is equal to the download speed, the size of the first sub-display region 111 is equal to the size of the second sub-display region 112. When the upload speed is faster than the download speed, the size of the first sub-display region 111 is larger than the size of the download speed interface 112.

The upload status display region 12 includes a third sub-display region 121 for showing the uploaded data and a forth sub-display region 122 for showing the data to be uploaded. For example, in FIG. 2, the third sub-display region 121 shows two files (A, B) and an application (C) that have been uploaded, and the forth sub-display region 122 shows two files (C, D) and an application (B) that are to be uploaded. The ratio of the size of the third sub-display region 121 to the size of the forth sub-display region 122 is proportional to the ratio of the size of the uploaded data to the size of the data to be uploaded.

The download status display region 13 includes a fifth sub-display region 131 for showing the downloaded data and a sixth sub-display region 132 for showing the data to be downloaded. The ratio of the size of the fifth sub-display region 131 to the size of the sixth sub-display region 132 is proportional to the ratio of the size of the downloaded data to the size of the data to be downloaded.

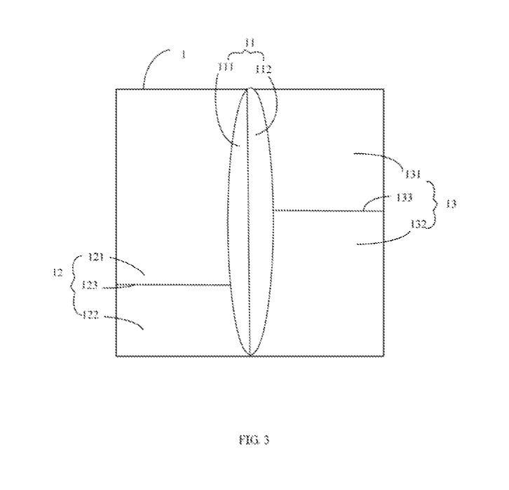

FIG. 2 and FIG. 3 cooperatively illustrate the changes of the third sub-display region 121 and the forth sub-display region 122 during the data upload process. The size of the third sub-display region 121 increases when more data is uploaded to the server. The line 123 moves downward to show a decreasing forth sub-display region 122 and a growing third sub-display region 121. FIGS. 2-3 further cooperatively illustrate the changes of the fifth sub-display region 131 and the sixth sub-display region 132 during the data download process. The size of the fifth sub-display region 131 increases when more data is downloaded to the terminal device 100. The line 133 moves downward to show a decreasing sixth sub-display region 132 and a growing fifth sub-display region 131.

The display control module 23 controls the display unit 30 to display and update the generated interface 1 in real time. In at least one embodiment, the display control module 23 controls to display the generated network status display region 11, the upload status display region 12, and the download status display region 13 side-by-side, the network status display region 11 is located between the upload status display region 12 and the download interface 13.

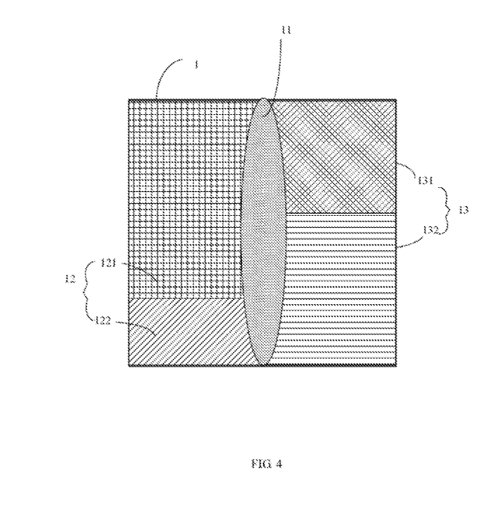

In another embodiment, the terminal device 100 also includes a storage unit 50. The storage unit 50 stores a relationship table recording a relationship between a number of display colors and display regions, such as illustrated in FIG. 4, the display color of the network status display region 11 is yellow, the display color of the third sub-display region 121 is blue, the display color of the forth sub-display region 122 is red, the display color of the fifth sub-display region 131 is green and the display color of the sixth sub-display region 132 is gray.

The display control module 23 controls the display unit 30 to display each display region with a color according to the stored relationship table.

In an alternative embodiment, the relationship table stored in the storage unit 50 further records a relationship between a number of display colors and the size of the data indicated by each display region. In at least one embodiment, during a upload process, if only less than 20 percent of data has been uploaded and more than 80 percent of data remains waiting for uploading, the display color of the third sub-display region 131 is light blue, if more than 50 percent of data has been uploaded; the display color of the third sub-display region 131 is dark green. The display control module 23 controls the display unit 30 to display and update the interface 1 in real time with the colors in the regions 121 and 122 changing during a data upload process, and display and update the interface in real time with the colors in the regions 131 and 132 changing during a data download process according to the transmitted information indicated by each display region and the relationship table.

The terminal device 100 includes an input unit 40 and an interaction module 24. The input unit 40 generates an interactive command to view the detail information of a sub-display region in response to an input operation of a user. The interaction module 24 identifies the particular sub-display region where the input operation is exerted, retrieves the detail information associated with the particular sub-display region and controls the display unit 30 to display the obtained detail information.

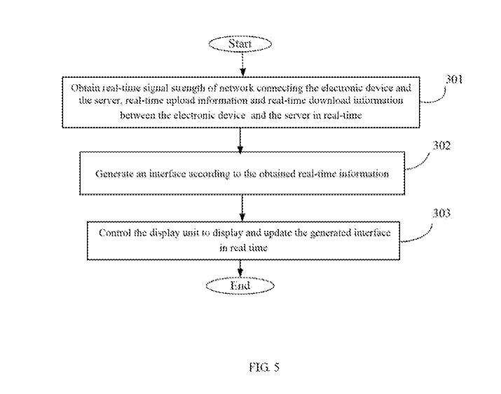

FIG. 5 illustrates a flowchart of a method for generating an interface showing network information. The method is applied to the terminal device 100. The terminal device 100 connects to a server and downloads data from the network server or uploads data from the terminal device 100 to the network server. The method includes steps, each of which is related to various components contained in the terminal device 100.

In block 301, the obtaining module 21 obtains real-time signal strength of network connecting the terminal device 100 and the server, real-time upload information and real-time download information between the terminal device 100 and the server in real-time.

In at least one embodiment, the signal strength of the network includes upload speed and download speed, the upload information includes amount and detail information of uploaded data, and amount and detail information of data to be uploaded; the download information includes amount and detail information of downloaded data, and amount and detail information of data to be uploaded.

In block 302, the generating module 22 generates the interface 1 according to the real-time obtained information obtained by the obtaining module 21.

The interface includes a network status display region 11, an upload status display region 12 and a download status display region 13. The network status display region 11 is for showing the signal strength of the network. The upload status display region 12 is for showing the upload information and the download status display region 13 showing the download information. The network status display region 11 includes a first sub-display region 111 and a second sub-display region 112. The first sub-display region 111 is for showing the upload speed of the network and the second sub-display region 112 is for showing the download speed of the network. The upload status display region 12 includes a third sub-display region 121 and a forth sub-display region 122. The third sub-display region 121 is for showing the uploaded data and the forth sub-display region 122 is for showing the data to be uploaded. The download icon 13 includes a fifth sub-display region 131 and a sixth sub-display region 132. The fifth sub-display region 131 is for showing the downloaded data and the sixth sub-display region 132 is for showing the data to be downloaded.

In block 303, the display control module 23 controls the display unit 30 to display and update the generated interface 1 in real time.

In at least one embodiment, the display control module 23 controls the display unit 30 to display the generated network status display region 11, the upload status display region 12, and the download status display region 13 side-by-side. In an alternative embodiment, the network status display region 11 is located between the upload status display region 12 and the download interface 13.

In another embodiment, the display control module 23 controls the display unit 30 to display and update each display region with a color according to the stored relationship table recoding the relationships between a number of display colors and sub-display regions. The display control module 23 controls the display unit 30 to display and update interface 1 in real time with colors according to the transmitted information indicating by each sub-display region and the relationship table recording a relationship between a number of display colors and the size of data indicating by the sub-display region.

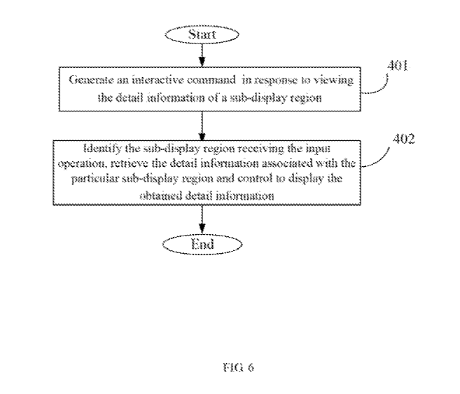

FIG. 6 illustrates a method for interacting with the interface displaying the network information. The method includes steps, each of which is related to various components of the terminal device 100.

In block 402, the input unit 40 generates an interactive command to viewing the detail information of a sub-display region in response to an input operation of a user.

In block 402, the interacting module 24 identifies the particular sub-display region where the input operation is exerted on, retrieves the detail information associated with the particular sub-display region and controls the display unit 30 to display the obtained detail information.

The interface displays the network information including signal strength of the network, the uploading information and downloading information and can interact with a user to make the user get the detailed information of the interface, which is user friendly.

Although the present disclosure has been described with reference to certain embodiments, persons having ordinary skill in the art may make various modifications and changes without departing from the scope of the disclosure. Therefore, the scope of the appended claims should not be limited to the description of the preferred embodiments described above.

What is claimed is:

1. A method for generating an interface showing network information, the method comprising:
obtaining real-time signal strength of a network connecting an terminal device and a server, real-time upload information and real-time download information between the terminal device and the server;
generating a network interface according to the obtained real-time information, the generated network interface comprising a network status display region, an upload status display region and a download status display region, the network status display region showing the signal strength of the network, the upload status display region showing the upload information, the download status display region showing the download information; and
displaying and updating the generated interface in real time.

2. The method as described in claim 1, wherein the signal strength of the network comprises upload speed and download speed.

3. The method described as in claim 2, further comprising
obtaining the upload speed and download speed of the network;
generating an first sub-display region for showing the upload speed and a second sub-display region for showing the download speed, wherein a ratio of a size of the first sub-display region to a size of the second sub-display region is proportional to a ratio of the upload speed to the download speed; and
displaying the first sub-display region and the second sub-display region.

4. The method described as in claim 1, wherein the upload information comprises size and detail information of uploaded data and size and detail information of data to be uploaded.

5. The method described as in claim 4, wherein further comprising
obtaining the uploaded data and data to be uploaded;
generating a third sub-display region for showing the uploaded data and a forth sub-display region for showing the data to be uploaded, wherein a ratio of a size of the third sub-display region to a size of the second forth-display region is proportional to a ratio of a size of the uploaded data to a size of the data to be uploaded;
displaying the third sub-display region and the forth sub-display region.

6. The method described as in claim 1, wherein the download information comprises size and detail information of downloaded data and size and detail information of data to be downloaded.

7. The method described as in claim 6, wherein further comprising:
obtaining the downloaded data and data to be downloaded;
generating a fifth sub-display region for showing the downloaded data and a sixth sub-display region for showing the data to be downloaded, wherein a ratio of a size of the fifth sub-display region to a size of the sixth forth-display region is proportional to a ratio of a size of the downloaded data to a size of the data to be downloaded;
displaying the fifth sub-display region and the six sub-display region.

8. The method described as in claim 1, wherein the network status display region, the upload status display region and the download status display region are displayed side-by-side.

9. The method described as in claim 8, further comprising displaying the generated interface with colors associating with display regions according to a relationship table recording relationships between a number of colors and the display regions.

10. A terminal device having an interface showing network information, the terminal device comprising:
a display unit, and
a processing unit comprising:
an obtaining module for obtaining real-time signal strength of a network connecting the terminal device and a server, real-time upload information and real-time download information between the terminal device and the server;
a generating module for generating a network interface according to the obtained real-time information, the generated network interface comprising a network status display region, an upload status display region and a download status display region, the network status region showing the signal strength of the network, the upload status display region showing the upload information, the download status display region showing the download information;
a display control module for controlling the display unit to display and update the generated interface in real time.

11. The terminal device described in claim 10, wherein the signal strength of the network comprises upload speed and download speed, the network status display region comprises a first sub-display region for showing the upload speed and a second sub-display region for showing the download speed.

12. The terminal device as described in claim 11, wherein a ratio of a size of the first sub-display region to a size of the second sub-display region is proportional to a ratio of the upload speed to the download speed.

13. The terminal device as described in claim 11, wherein the upload information comprises size and detail information of uploaded data and size and detail information of data to be uploaded, the upload status display region comprises a third sub-display region for showing the uploaded data and a forth sub-display region for showing the data to be uploaded.

14. The terminal device as described in claim 13, wherein a ratio of a size of the third sub-display region to a size of a forth sub-display region is proportional to a ratio of a size of the uploaded data to a size of the date to be uploaded.

15. The terminal device as described in claim 14, wherein the download information comprises size and detail information of downloaded data and size and detail information of data to be downloaded, the download status display region comprises a fifth sub-display region for showing the downloaded data and a sixth sub-display region for showing the data to be downloaded.

16. The terminal device as described in claim 15, wherein a ratio of a size of the fifth sub-display region to a size of the sixth sub-display region is proportional to a ratio of a size of the downloaded data to a size of the date to be downloaded.

17. The terminal device described in claim 16, wherein further comprising a storage unit for storing a relationship table recording the relationships between a number of colors and sub-display regions, the display control module is configured for controlling the display unit to display generated interface with each of sub-display regions having a color according to the relationship table.

18. The terminal device described in claim 17, wherein the relationship table further records a relationship between display colors and the size of data indicated by each sun-display region; the display control module controls the display unit to display and update the generated interface with each sub-display region having a color according to the transmitted size indicated by each sub-display region and the relationship table.

19. The terminal device as described in claim 10, wherein the display control module is configured for controlling the display unit to display the network status display region, the upload status display region and the down status display region side-by-side.

20. The terminal device as described in claim 19, wherein the network status display region is located between the upload status display region and the down status display region.
